(19) United States
(12) Patent Application Publication
(10) Pub. No.: US 2006/0069700 A1
(43) Pub. Date: Mar. 30, 2006

(54) Generating relational structure for non-relational messages

(76) Inventors: Justin Marston, Richmond (GB); Andrew Stuart Hatch, Hurworth-on-Tees (GB)

Correspondence Address: FENWICK & WEST LLP, SILICON VALLEY CENTER, 801 CALIFORNIA STREET, MOUNTAIN VIEW, CA, 94041, US

(21) Appl. No.: 11/230,934

(22) Filed: Sep. 19, 2005

Related U.S. Application Data
(60) Provisional application No. 60/612,552, filed on Sep. 22, 2004.

(51) Int. Cl. G06F 17/00

(52) U.S. Cl. 707/104.1

(57) ABSTRACT

A messaging server (112) provides a message store (116) for storing messages in a relational manner. A set of related messages, such as an email string between two or more people, is represented as a message container (200) having relational references to one or more submessages (210, 212, 214). The messaging server (112) processes non-relational messages sent by the server by inserting (516) tags that uniquely identify components within the message. The messaging server (112) also processes tagged or untagged non-relational messages received by the server to create (616, 618) relational counterparts in the message store (116). Relational searches can be executed on the messages in the message store (116) to perform audits or forensic analyses of the messages.

### CROSS-REFERENCE TO RELATED APPLICATIONS

This application claims the benefit of U.S. Provisional Application No. 60/612,552, filed Sep. 22, 2004, which is hereby incorporated by reference herein. This application is related to U.S. Utility application Ser. Nos. 11/129,231 and 11/129,212, both of which were filed on May 12, 2005, and Ser. No. 11/004,638, filed Dec. 3, 2004, all of which are hereby incorporated by reference herein.

### BACKGROUND OF THE INVENTION

1. Field of the Invention

This invention pertains in general to electronic messaging and in particular to organizing electronic messages in a relational manner.

2. Description of the Related Art

Before the introduction of e-mail, business users relied on two forms of communication—the phone and the business letter. The former was momentary and casual, the latter was retained as a business record and considered formal. E-mail has blurred those two communication requirements into one tool—people use it both formally and casually, but it is retained for an indefinite time period (typically years) depending on how an enterprise's Information Technology (IT) system has been set up.

Enterprises are now searching for a way to deal with the problem of separating communications that constitute business records from the general ‘chatter’ of e-mail. Such business records must be retained in a manner that reflects the business processes to which the content relates.

A further problem with current e-mail systems is that messages are just simple text strings. When a user writes a message, it is formed into the first e-mail, but may then go on to be included in many other e-mails during its lifetime. This results in many copies of the same, user-authored, message in different, unrelated, mail “snapshots.” This is an inefficient way to store messages that makes searching difficult and enforcing a retention policy, access rights, security or any other property onto the messages nearly impossible. Moreover, it is difficult to perform a forensic analysis on a set of messages, such as determining who created, read, and/or forwarded particular messages. These are very significant problems for companies attempting to achieve compliance with internal or government-mandated regulations, and for investigators attempting to analyze compliance with such regulations.

Therefore, there is a need in the art for an electronic messaging system that structures emails and other electronic messages in a manner that allows the messages to be efficiently searched and analyzed.

### BRIEF SUMMARY OF THE INVENTION

The above need is met by a messaging system that treats a set of related messages, such as an email string between two or more people, as a message container (200) having relational references to one or more submessages (210, 212, 214). A messaging server (112) stores the messages and submessages as discrete message components within a relational message store (116). Depending upon the embodiment, the messaging server (112) can send and receive messages in relational and/or non-relational formats.

In one embodiment, the messaging server (112) tags (516) non-relational messages with information that will assist a messaging server that receives the messages in creating relational counterparts of the messages. The formats and types of tags added to a message depend upon the format in which the message is sent. In general, the tags uniquely identify the message itself and each message component within it.

In one embodiment, the messaging server (112) processes non-relational messages it receives to create relational counterparts of the messages in the message store (116). The received messages can be tagged or untagged. For an untagged message, the messaging server (112) analyzes the message to determine whether it contains multiple submessages. For each submessage, the messaging server (112) creates a new message component within the message store (116) and/or updates the relational links in the message store to account for the received message. For a tagged message, the messaging server (112) extracts the tag information and updates the relational data in the message store (116) in response.

In one embodiment, the messaging server (112) supports relational queries on the message components in the message store (116). Such queries can be used to audit usage and/or perform a forensic analysis of the messaging system.

### BRIEF DESCRIPTION OF THE DRAWINGS

FIG. 1 is a high-level block diagram illustrating an environment including an embodiment of a messaging system.

FIG. 2 is a block diagram illustrating a representation of a message exchanged according to an embodiment of the messaging system.

FIG. 3 illustrates a set of interactions that explain the relationship among messages, current submessages, and history submessages.

FIG. 4 is a high-level block diagram illustrating modules within a messaging server according to one embodiment of the messaging system.

FIG. 5 is a flow chart illustrating steps performed by the messaging server to perform upstream processing according to one embodiment.

FIG. 6 is a flow chart illustrating steps performed by the messaging server to perform downstream processing according to one embodiment.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE PREFERRED EMBODIMENTS

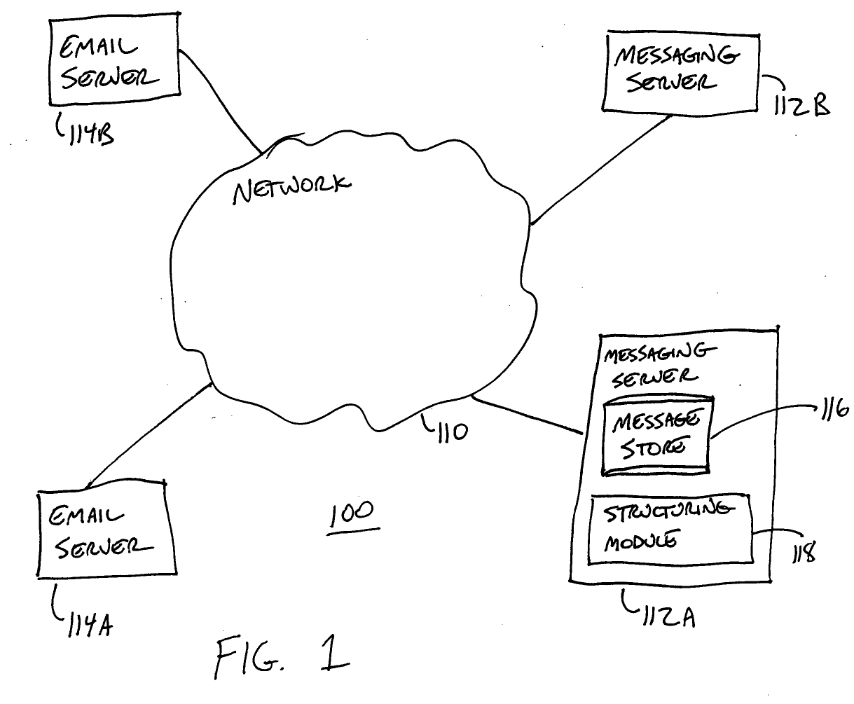

FIG. 1 is a high-level block diagram illustrating an environment 100 including an embodiment of a messaging system. The environment 100 of FIG. 1 includes a network 110, two messaging servers 112A, 112B, and two email servers 114A, 114B. End-users use clients of the messaging 112 and email 114 servers to exchange messages with other end-users. An end-user can perform various actions on messages, including composing, sending, reading, replying to, and forwarding.

FIG. 1 and the other figures use like reference numerals to identify like elements. A letter after a reference numeral, such as “114A,” indicates that the text refers specifically to the element having that particular reference numeral. A reference numeral in the text without a following letter, such as “114,” refers to any or all of the elements in the figures bearing that reference numeral (e.g. “114” in the text refers to reference numerals “114A” or “114B” in the figures).

The network 110 enables data communication between and among the entities connected to the network and allows the entities to exchange messages. In one embodiment, the network 110 is the Internet. The network 110 can also utilize dedicated or private communications links that are not necessarily part of the Internet. In one embodiment, the network 110 uses standard communications technologies and/or protocols. Thus, the network 110 can include links using technologies such as Ethernet, 802.11, integrated services digital network (ISDN), digital subscriber line (DSL), asynchronous transfer mode (ATM), etc. Similarly, the networking protocols used on the network 110 can include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 110 can be represented using technologies and/or formats including the hypertext markup language (HTML), the extensible markup language (XML), etc. In addition, all or some of links can be encrypted using conventional encryption technologies such as the secure sockets layer (SSL), Secure HTTP and/or virtual private networks (VPNs). In another embodiment, the entities can use custom and/or dedicated data communications technologies instead of, or in addition to, the ones described above.

As used herein, the term “message” refers to a data communication sent by one end-user to one or more end-users of the messaging system shown in FIG. 1 or another messaging system. In one embodiment, some of the messages are represented as containers having relational references to content. These messages are generally referred to as “relational messages.” Some of the messages, in contrast, are non-relational messages such as emails, Short Message Service (SMS) messages, Instant Messages (IMs), Multi-Media Message (MMS) and/or other types of messages. In addition, non-relational messages can include media files, such as discrete and/or streaming audio and/or video, still images, etc.

The messaging servers 112 of FIG. 1 are adapted to support communications using relational messages. The email servers 114 of FIG. 1 are adapted to support communications using non-relational messages. These latter servers 114 are called email servers because they are typically utilized for email messaging, but one of skill in the art will appreciate that the email servers can support other messaging types instead of, or in addition to, email. Some of the messaging 112 and/or email 114 servers support both relational and non-relational messages. Although FIG. 1 illustrates only two messaging servers 112 and two email servers 114, embodiments of the messaging system can have many of each type of server. In one embodiment, the messaging 112 and email 114 servers are located within different enterprises.

For purposes of clarity, messaging server 112A is expanded to illustrate additional elements within it according to one embodiment. Other messaging servers 112 within the system can have the same and/or other elements. The messaging server 112A exchanges relational messages with the other messaging server 112B and non-relational messages with the email servers 114. In one embodiment, the messaging server 112A includes tags with the non-relational messages it sends that uniquely identify the messages and reference them in a relational manner.

In one embodiment, the messaging server 112A includes a relational message store 116 that stores relational messages sent and received by the messaging server 112A. In addition, the message store 116 stores relational counterparts of non-relational messages received by the messaging server 112A. The message store 116 stores the relational messages in a format that allows rapid searching and retrieval.

The messaging server 112A includes a structuring module 118 for generating a relational structure and relational messages from non-relational messages. The relational structure is utilized to store the counterpart relational messages in the message store 116. In one embodiment, the structuring module 118 operates in real-time to create relational counterparts of non-relational messages received or sent by the messaging server 112A. In another embodiment, the structuring module 118 operates in an offline manner to process a corpus of non-relational messages.

By storing relational messages and/or relational versions of non-relational messages in a relational message store 116, the messaging server 112 allows efficient and sophisticated analyses of messages exchanged in the messaging system. These analyses can identify, for example, the people who sent given messages, the recipients of the messages, the people who responded to or forwarded the messages, etc. Such analyses are useful for performing security audits and/or forensic studies of the usage of the messaging system. In addition, the messaging server 112 eases the process of migrating from a legacy non-relational messaging system to a newer relational messaging system.

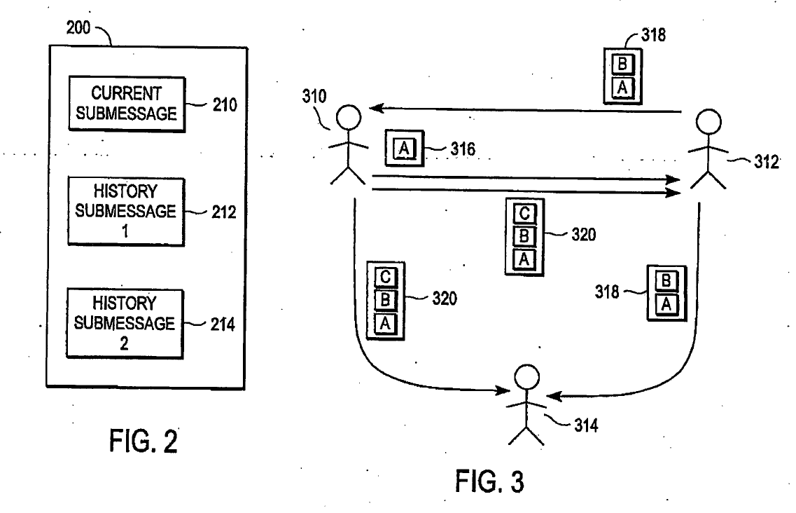

FIG. 2 is a block diagram illustrating a representation of a relational message 200 exchanged according to an embodiment of the messaging system. This message can be, for example, a native relational message or a relational representation of a non-relational message. The relational message 200 can be thought of as a container with relational references. The container itself does not contain content, but rather points to submessages and/or attachments in which content resides. In addition, the container can point to other information about the message, such as audit, security, and governance policy information. A message can also be conceptualized as a document having multiple paragraphs, where each paragraph can be individually identified and isolated. Multiple people can contribute paragraphs to the document, and the document itself can be formed of references to paragraphs written by the different authors. In one embodiment, the message container is extensible, and can point to other types of data such as patient codes, embedded graphics, and questionnaires. This description uses the term “message components” to refer to the message, submessages, attachments, etc.

When an end-user composes and sends a message, she is actually composing a submessage, and then sending a message 200 containing a reference to the submessage 200 to other end-users. The submessage composed and sent by the end-user is called the “current submessage.” Any submessages that were previously in the message are called “history submessages.” For example, if an end-user receives a message containing one submessage, at the time of receipt the single submessage is the current submessage. When the end-user composes and sends a reply, the submessage containing the reply becomes the current submessage, and the other submessage becomes a history submessage.

The end-user can also associate one or more attachments with a submessage. In one embodiment, the attachments are relationally-referenced within a message in the same manner as submessages. Thus, attachments can be treated in the same manner as submessages and descriptions of submessages contained herein are equally applicable to attachments. The exemplary message 200 of FIG. 2 contains one current submessage 210 and two history submessages 212, 214 representing previously sent submessages within the message 200.

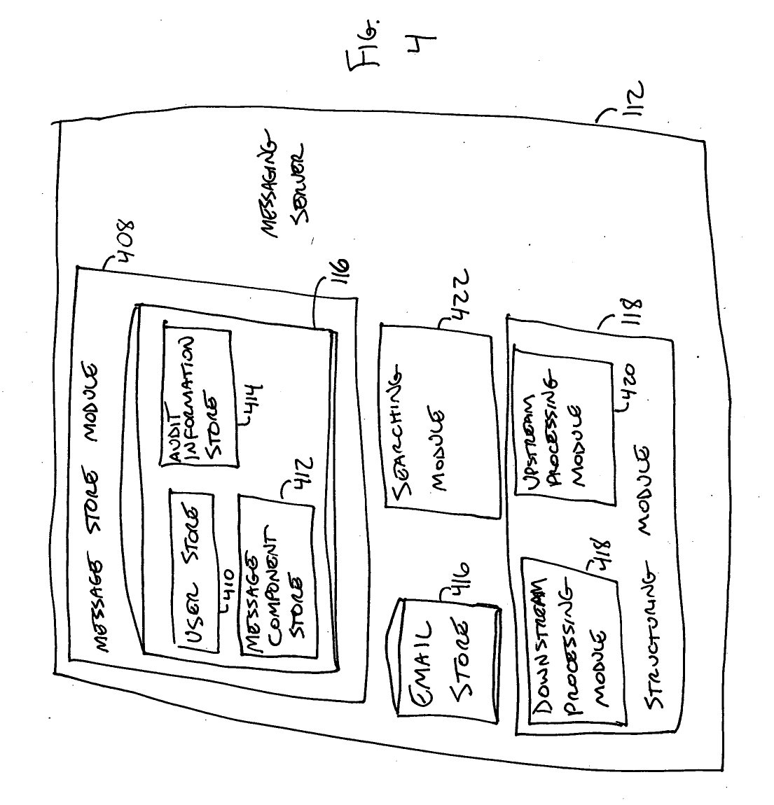

FIG. 3 illustrates a set of interactions that explain the relationship among messages 200, current submessages 210, and history submessages 212, 214. The figure illustrates three people, Alice 310, John 312, and Peter 314. Initially, Alice 310 composes a message 316 containing submessage A and sends it to John 312. John 312 replies 318 and also copies the message to Peter 314. In the reply 318, submessage B is the current submessage and submessage A becomes a history submessage. Next, Alice 310 replies to both John 312 and Peter 314 and sends a third version 320 of the message having a new current submessage C, and two history submessages A and B.

For purposes of clarity, this description occasionally uses the terms “submessage,” “current submessage,” and “history submessage” to refer to parts of non-relational messages. It should be understood that these terms generally refer to the parts of a non-relational message that serve the same function as their relational counterparts. For example, if an end-user receives a non-relational email and replies to it (and incorporates text from the original email in the reply), the body of the reply becomes the current submessage and the text from the original email becomes the history submessage.

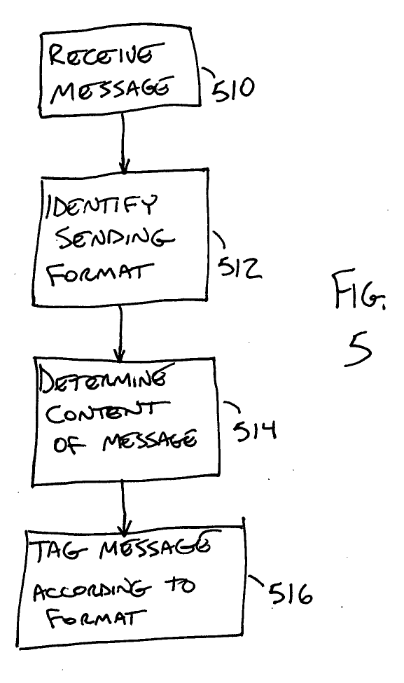

FIG. 4 is a high-level block diagram illustrating modules within a messaging server 112 according to one embodiment of the messaging system. As used herein, the term “module” refers computer program logic for providing the specified functionality. A module can be implemented in hardware, firmware, and/or software. Those of skill in the art will recognize that the messaging server 112 and other entities described herein can be implemented by computers systems executing computer program modules.

FIG. 4 illustrates a relational message store module 408 that manages the message store 116. In one embodiment, the message store 116 includes a relational database that stores information about the messages exchanged using the messaging system. As used herein, the term “database” refers to an information store and does not imply that the data within the database are organized in a particular structure beyond that described herein. Although only a single message store 116 is illustrated in FIG. 4, embodiments of the messaging server 112 can utilize multiple databases or other data stores. In addition, the message store 116 can be local or remote to the messaging server 112. The relational message store module 408 supports relational queries on the message store 116, such as queries encoded in the structured query language (SQL) and provides interfaces that allow other modules to add, delete and/or modify data within it.

In one embodiment, the message store 116 includes a user store 410 for storing information about end-users using the messaging system. The stored information includes the network addresses (e.g., email addresses) of the end-users and, depending upon the embodiment, may store additional data such as the names of the end-users, their roles or other job descriptions, and/or their security clearances.

A message component store 412 stores message components exchanged within the messaging system. As described above, the message components include messages, submessages, and attachments. In one embodiment, the message component store 412 associates a unique identifier with each message component. The identifier allows each component to be referenced separately and consistently.

In one embodiment, a message, stored in the message component store 412 includes a reference to a set of submessages and/or attachments, and to audit information describing operations performed on the message. A submessage component, in turn, includes information such as references to “to,” “cc,” and “from” identities, a submessage body, a subject line, and the dates that the submessage was sent and/or received.

In one embodiment, a submessage component also includes data created and/or utilized to create relational message counterparts to non-relational messages. These data include “from,” “to,” and “cc” email addresses and names, an “original” flag, and a hash of the submessage body. In one embodiment, the submessage body hash is formed from the alphanumeric characters in the text of the submessage body. Only alphanumeric characters are used in order to minimize alterations on the text made by messaging clients, e.g., to remove chevron characters (“>”) inserted when a message is replied-to. The hash is generated by a cryptographic function such as the MD5 or SHA-1 hash algorithms and serves to uniquely identify the submessage body.

An attachment message component is preferably stored in the message component store 412 as-is in order to preserve the integrity of the attachment. In an embodiment, the message component store 412 associates a hash with each attachment. The hash is generated using a cryptographic function and serves to uniquely identify the attachment.

An audit information store 414 in the message store 116 stores audit information describing usage of the messaging system. Audit information thus indicates which end-users composed which submessages, which users read which submessages, which users replied to and/or forwarded which submessages, etc. The audit information can also describe characteristics of the message components such as sensitivity levels for particular submessages.

In one embodiment, an email store 416 in the messaging server 112 stores emails and/or other non-relational messages received by the messaging server. The characteristics of the email store 416 depend upon the embodiment. In one embodiment, the email store 416 includes a collection of emails formatted for use by a conventional email program. For example, the email store 416 can include a MICROSOFT EXCHANGE server holding email messages. In another embodiment, the email store 416 is a collection of one or more text strings forming an email corpus. In yet another embodiment, the email store 416 is a buffer utilized to hold only a few non-relational emails for which relational counterparts are being created.

In general, each email in the email store 416 includes a set of headers, a message body, and zero or more attachments. The headers and message body are typically represented as strings of 7-bit characters, and the attachments are typically encoded using the Multipurpose Internet Mail Extensions (MIME) protocol. The headers contain information such as the sender and recipient names and email addresses, the date the email was sent, a message identification, the email client utilized by the sender, routing information, references, and “in reply to” identifiers. The exact headers present are largely determined by the email servers and clients that handled the emails, and some headers might not be present.

The message body contains the text of the message. One element of complexity in the message body is the treatment of other messages in the same email chain (i.e., history submessages). For example, when a person responds or forwards an email, different email clients and/or servers will handle the original email differently. On a reply or forward event, some email clients will not append any of the original email to the reply or forwarded message. Some email clients will append the original message. They use delimiters followed by the email, for example:

-----Original Message-----

lines from the original message

In some configurations the message will also include a subset of header information:

-----Original Message-----

From: John Doe [mailto:john.doe@mycompany.null]

Sent: 02 Jun. 2004

To: Jane Doe

Subject: A message

Lines from the original message

The exact formatting will change from mail client to mail client, and also with the individual settings set by end-users. An example of a similar technique from a different mail client is given below:

“John Doe”<john.doe@mycompany.null> on 01/06/2004 13:14:18

To: “Jane Doe”<jane.doe@mycompany.null>

cc:

Subject: FW: message

Lines from the original message

Some clients prefix each line with an indentation character and start the quotation with a statement of authorship, for example:

On 26th May 2004 at 15:10, John Doe wrote:

>Lines from the original mail

In addition, an email client may also wrap characters at a certain line length, e.g. 76 characters, resulting in an inconsistent indentation when there are multiple replies, for example:

>>hostel is happy for you to take only 5 beds out of the six.

>However I was

>>told that this dorm needs to be booked soon, as they tend to go

>quickly—

>>the guy I spoke to said that we probably have a week before

The structuring module 118 can parse these different email formats in order to generating relational structure from non-relational messages stored in the email store 416. In one embodiment, the structuring module 118 includes a downstream processing module 418 for parsing the messages in the email store 416 and creating the corresponding relational messages in the message store 116. The downstream processing attempts to “piece back together” the context of the original messages and to store each unique message as a single instance within the message store 116. Thus, the downstream processing module 418 converts a set of non-relational messages into a set of relational messages like those illustrated in the representations and interactions of FIGS. 2-3.

In one embodiment, the structuring module 118 further includes an upstream processing module 420 for encoding emails and/or other non-relational messages sent by the messaging server 112 in order to enable subsequent downstream processing by the same and/or another messaging server 112. In one embodiment, the upstream processing module 420 is located at a gateway where it can access and encode all messages sent by an enterprise or other entity operating a messaging 112 or email server 114. For example, the upstream processing module 420 can be located at a simple mail transport protocol (SMTP) server. In another embodiment, the upstream processing module 420 is incorporated into a client so that messages sent by the client are encoded for later processing. The operations of the downstream 418 and upstream 420 processing modules are described in more detail below.

In one embodiment, the messaging server 112 includes a searching module 422 for generating and executing relational queries on the messages in the relational messaging store 116. In one embodiment, the searching module 422 presents a user interface (UI) to an administrator and/or other end-user that allows the administrator to generate and execute SQL queries on the message store 116 and view the results. In other embodiments, the searching module 422 receives SQL queries from another entity, executes the queries on the message store 116, and returns the results.

The relational nature of the messages in the message store 116 allows rapid querying of content, and particularly improves the ability to perform queries with respect to message components objects as opposed to plain text representations of messages. Examples of human readable search queries include:

“Show all emails I received that contain this message component.”

“Show all emails I sent that contain this message component.”

“Show every email sent or received by the Investment Bankers set of end-users that contains this message component.”

“Show every recipient who received this message component.”

“Show the entire path of this message component through the messaging system.”

“How many unique emails contained this message fragment?”

Such queries can be used to audit usage and/or perform a forensic analysis of the messaging system. For example, an investigator can research whether emails containing restricted information were sent by certain end-users, and whether the recipients of those emails forwarded the messages to third parties. An investigator can also search for types of information such as “popularity,” which in one embodiment is measured by the number of times that a particular message component is included within messages.

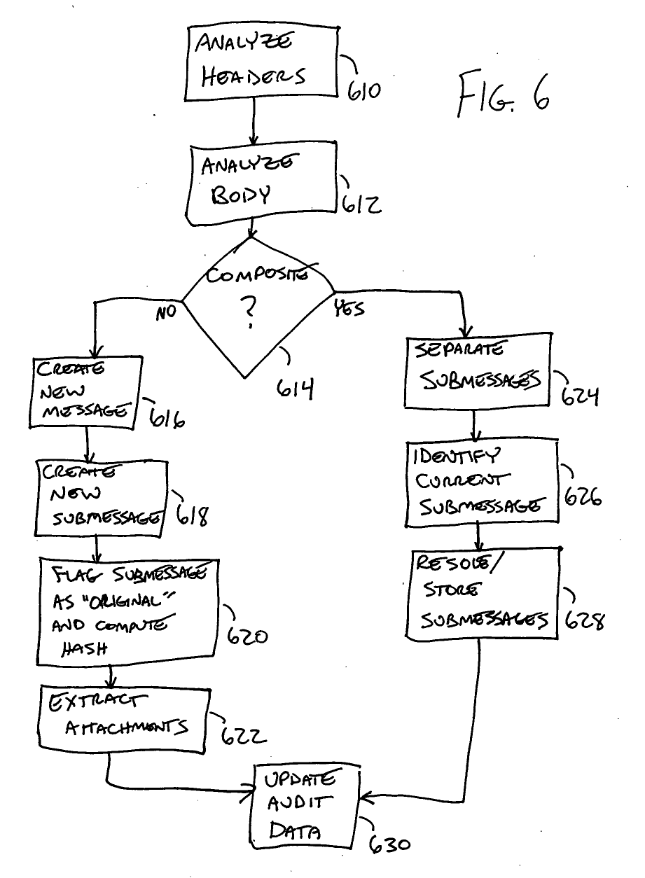

FIG. 5 is a flow chart illustrating steps performed by the messaging server 112 to perform upstream processing according to one embodiment. These steps can be performed by the upstream processing module 420 of the structuring module 118 and/or by other modules within the messaging server 112 or elsewhere in the messaging system. Other embodiments can perform different and/or additional steps than the ones shown in FIG. 5. Moreover, other embodiments can perform the steps in different orders.

Initially, the messaging server 112 receives 510 the outbound non-relational message to be processed. The messaging server 112 analyzes the message to identify 512 the format in which it is being sent. Even though emails and many other types of non-relational messages are at their core text strings, the text can represent the message in a variety of different formats. For example, an email can be encoded in a plaintext format, in a rich text format (RTF), or in an HTML format.

The messaging server 112 also determines 514 the content of the message. The messaging server 112 determines whether the message contains any attachments and/or whether the message is a composite (i.e., whether the message includes one or more history submessages that are part of the message chain). In one embodiment, the messaging server 112 determines whether the message is composite by searching the message for text patterns such as “Re:”, “----Original Message----”, or other patterns like those described above that indicate that a previous message is present. Partial pattern matches can be used to generate a score, and scores above a threshold can be said to indicate that the message is composite.

The messaging server 112 next tags 516 the message to identify the content within it. In general, tagging 516 is performed by inserting headers and/or other information into the message that will allow the message to be downstream processed by a messaging server 112 that receives the message. Different formats of messages support different types of tags.

If the message is sent as plaintext, tags are used to identify each individual submessage in the message. Also, a header is added to the message along with the standard headers. For example, if the message is an email containing a single current submessage (i.e., containing only an original message), the message can be tagged 516 as follows:

Mon, 16 Sep 2004 00:01:02 +0300

To: “John Doe”<john.doe@otherhost.net>

From: “Jane Doe”<jane.doe@bluespace.host.net>

Subject: Lunchtime meeting

X-Mailer: BlueSpace SMTP Gateway v3.01.7788

X-Priority: 3 (Normal)

X-BLSP-V: 3.01.778

X-BLSP-ID: <SRV1MMBuado7fusvV6v00000003@blspgateway1.host.net>

Return-Path: jane.doe@bluespace.host.net

Message-ID: <SRV1MMBuado7fusvV6v00000003@blspgateway1.host.net>

Date: 16 Sep 2004 00:01:02 +0300

Dear John,

Hope all is well with you. Lets meet this lunchtime.

Regards,

Jane.

-----BEGIN BlueSpace ID-----

Version: 3.01.778

BLSP-ID: SRV1MMBuado7fusvV6v00000003@blspgateway1.host.net

SUBID:

iQCVAwUBMJrRF2N9oWBghPDJAQE9UQQAtl@blspgateway1.host.net

-----END BlueSpace ID-----

The headers section of the email includes an “X-BLSP-ID” tag that uniquely identifies the email and a X-BLSP-V tag that states the version of the messaging server 112 used to process the email. Also, the email body includes a “BlueSpace ID” tag that identifies the version of the messaging server 112, the unique identifier for the message, and the unique identifier for the submessage. Different embodiments format the tags differently and/or include different information in the tags.

If the email contains a single submessage and two attachments, one embodiment of the messaging server 112 tags 516 the email as follows:

Mon, 16 Sep 2004 00:01:02 +0300

To: “John Doe”<john.doe@otherhost.net>

From: “Jane Doe”<jane.doe@bluespace.host.net>

Subject: Meeting pre-reads

X-Mailer: BlueSpace SMTP Gateway v3.01.7788

X-Priority: 3 (Normal)

X-BLSP-V: 3.01.778

X-BLSP-ID: <SRV1MMBuado7fusvV6v00000003@blspgateway1.host.net>

X-BLSP-AT: qLQRkYNoBActFBZmh;PIcEmI5iFd9boEgvp

Return-Path: jane.doe@bluespace.host.net

Message-ID: <SRV1MMBuado7fusvV6v00000003@blspgateway1.host.net>

Date: 16 Sep 2004 00:01:02 +0300

Dear John,

Please find the two documents attached.

Regards,

Jane.

-----BEGIN BlueSpace ID-----

Version: 3.01.778

BLSP-ID: SRV1MMBuado7fusvV6v00000003@blspgateway1.host.net

SUBID:

iQCVAwUBMJrRF2N9oWBghPDJAQE9UQQAtl@blspgateway1.host.net

ATTACHMENTS: qLQRkYNoBActFBZmh;PIcEmI5iFd9boEgvp

-----END BlueSpace ID-----

In this tagging example, the messaging server 112 inserts a line in the header, “X-BLSP-AT: qLQRkYNoBActFBZmh;PIcEmI5iFd9boEgvp,” that provides the identifications for the two attachments in the email. In addition, the messaging server 112 inserts a tag in the message body (within the “BlueSpace ID” tag) that lists the attachment identifiers.

Consider a third example where the email message includes multiple submessages. In this case, an embodiment of the messaging server 112 tags 516 by inserting identifiers for each submessage as follows:

Mon, 16 Sep 2004 00:01:02 +0300

To: “John Doe”<john.doe@otherhost.net>

From: “Jane Doe”<jane.doe@bluespace.host.net>

Subject: FWD: Re: Agenda

X-Mailer: BlueSpace SMTP Gateway v3.01.7788

X-Priority: 3 (Normal)

X-BLSP-V: 3.01.778

X-BLSP-ID: <SRV1MMBuado7fusvV6v00000003@blspgateway1.host.net>

Return-Path: jane.doe@bluespace.host.net

Message-ID: <SRV1MMBuado7fusvV6v00000003blspgateway1.host.net>

Date: 16 Sep 2004 00:01:02 +0300

Dear John,

Would you be able to attend this meeting?

Regards,

Jane.

-----BEGIN BlueSpace ID-----

SUBID:

iQCVAwUBMJrRF2N9oWBghPDJAQE9UQQAtl@blspgateway1.host.net

-----END BlueSpace ID-----

-----Original Message-----

From: Michael Smith

Sent: 15 Sep 2004 13:45

To: Jane Doe

Subject: Re: Agenda

Jane,

Could you make sure your team has been invited.

Thanks,

Michael

-----BEGIN BlueSpace ID-----

SUBID:

boEgvpirHtIREEqLQRkYNoBAIREEqtFBZm@blspgateway1.host.net

-----END BlueSpace ID-----

-----Original Message-----

From: Jane Doe

Sent: 14 Sep 2004 16:23

To: Michael Smith

Subject: Agenda

Michael,

I've been advised of the meeting tomorrow—my team will be able to attend if required.

Regards,

Jane.

----BEGIN BlueSpace ID-----

Version: 3.01.778

BLSP-ID: SRV1MMBuado7fusvV6v00000003@blspgateway1.host.net

SUBID:

AK8AFHA29ZMCAa29aF09aRtPLm900aSVnj@blspgateway1.host.net

-----END BlueSpace ID-----

In this example, the messaging server 112 adds headers that identify the message ID and the version. In addition, the messaging server 112 inserts a tag after the body of each submessage that provides a unique identifier for the submessage. Only the tag of the final submessage contains the version and BLSP-ID information because it is not necessary to repeat this information for each submessage.

If the sending format of the message is HTML or another format that supports sophisticated tagging, an embodiment of the messaging server 112 uses a richer set of tags for the message. In one embodiment, the messaging server 112 uses tags to tag 516 the entire message, the individual submessages, all attachments, and also individual paragraphs. These tags are preferably encoded so that they will not be displayed when a client shows the message.

For example, an embodiment of the messaging server 112 tags 516 an HTML version of the multiple submessage email example described above as follows:

Mon, 16 Sep 2004 00:01:02 +0300

To: “John Doe”<john.doe@otherhost.net>

From: “Jane Doe”<jane.doe@bluespace.host.net>

Subject: FWD: Re: Agenda

X-Mailer: BlueSpace SMTP Gateway v3.01.7788

X-Priority: 3 (Normal)

X-BLSP-V: 3.01.778

X-BLSP-ID: <SRV1MMBuado7fusvV6v00000003@blspgateway1.host.net>

Return-Path: jane.doe@bluespace.host.net

Message-ID: <SRV 1MMBuado7fusvV6v00000003@blspgateway1.host.net>

Date: 16 Sep 2004 00:01:02 +0300

<!DOCTYPE HTML PUBLIC “-//W3C//DTD HTML 4.0 Transitional//EN”>

<HTML><BODY>

<!—-BEGIN BLSP-ID

SRV1MMBuado7fusvV6v00000003@blspgateway1.host.net-->

<!—-BLSPV 3.01.778-->

<!—-BEGIN BLSPSUBID

iQCVAwUBMJrRF2N9oWBghPQAtl@blspgateway1.host.net-->

<P><!—-BLSP P1S-->Dear John,<!—-BLSP P1E--></P>

<P><!—-BLSP P2S-->Would you be able to attend this meeting?<!—-BLSP P2E--></P>

<P><!—-BLSP P3S-->Regards,<!—-BLSP P3E--></P>

<P><!—-BLSP P4S-->Jane.<!—-BLSP P4E--></P>

<!—-END BLSPSUBID

iQCVAwUBMJrRF2N9oWBghPQAtl@blspgateway1.host.net-->

<!—-BEGIN BLSPSUBID

boEgvpirHtIREEqLQRkYNoBA@blspgateway1.host.net-->

<BR><BR><BR>

<P><!—-BLSP E1S-->----Original Message-----<!—-BLSP E1E-->

<P><!—-BLSP E2S-->From: Michael Smith<!—-BLSP E2E-->

<P><!—-BLSP E3S-->Sent: 15 Sep 2004 13:45<!—-BLSP E3E--></P>

<P><!—-BLSP E4S-->To: Jane Doe<!—-BLSP E4E--></P>

<P><!—-BLSP E5S-->Subject: Re: Agenda<!—-BLSP E5E--></P>

<P><!—-BLSP P1S-->Jane, <!—-BLSP P1E--></P>

<P><!—-BLSP P2S-->Could you make sure your team has been invited. <!—-BLSP P2E--></P>

<P><!—-BLSP P3S-->Thanks, <!—-BLSP P3E--></P>

<P><!—-BLSP P4S-->Michael<!—-BLSP P4E--></P>

<!—-END BLSPSUBID

boEgvpirHtIREEqLQRkYNoBA@blspgateway1.host.net-->

<!—-BEGIN BLSPSUBID

AK8AFHA29ZMCAa29aFSVnj@blspgateway1.host.net-->

<BR><BR><BR>

<P><!—-BLSP E1S-->----Original Message-----<!—-BLSP E1E-->

<P><!—-BLSP E2S-->From: Jane Doe<!—-BLSP E2E-->

<P><!—-BLSP E3S-->Sent: 14 Sep 2004 16:23<!—-BLSP E3E-->

<P><!—-BLSP E4S-->To: Michael Smith<!—-BLSP E4E-->

<P><!—-BLSP E5S-->Subject: Agenda<!—-BLSP E5E-->

<P><!—-BLSP E6S-->Michael, <!—-BLSP E6E-->

<P><!—-BLSP P1S-->I've been advised of the meeting tomorrow—my team will be able to attend if required. <!—-BLSP P1E-->

<P><!—-BLSP P2S-->Regards, <!—-BLSP P2E-->

<P><!—-BLSP P3S-->Jane. <!—-BLSP P3E-->

<!—-BLSP-ATTACHMENTS qLQRkYNoBActFBZmh;PIcEmI5iFd9boEgvp-->

<!—-END BLSPSUBID

AK8AFHA29ZMCAa29aFSVnj@blspgateway1.host.net-->

<!—-END BLSP-ID:

SRV1MMBuado7fusvV6v00000003@blspgateway1.host.net-->

</BODY>

</HTML>

In this example, the meaning of the tags is as follows:

BEGIN BLSP-ID Start of the message

END BLSP-ID End of the message

BEGIN BLSPSUBID Start of a submessage

END BLSPSUBID End of a submessage

BLSPV Message Server version

BLSP P1S Start of a paragraph of content

BLSP P1S End of a paragraph of content

BLSP E1S Start of an extra paragraph (not direct content, but extra formatting.)

BLSP E1E End of an extra paragraph

BLSP-ATTACHMENTS List of attachments associated with submessage.

Other embodiments of the messaging server 112 tag HTML messages in a different manner.

FIG. 6 is a flow chart illustrating steps performed by the messaging server 112 to perform downstream processing according to one embodiment. These steps can be performed by the downstream processing module 418 of the structuring module 118 and/or by other modules within the messaging server 112 or elsewhere in the messaging system. Other embodiments can perform different and/or additional steps than the ones shown in FIG. 6. Moreover, other embodiments can perform the steps in different orders.

The flow chart of FIG. 6 describes the downstream processing of a single email stored in the email store 416. This processing can be performed, for example, in real time on an email received by the messaging server 112. In another example, the steps of FIG. 6 can represent an instance of the offline processing of emails in a large corpus that an administrator loaded onto the email store 416.

Initially, the messaging server 112 analyzes the headers 610 of the email to determine basic information about the email. As shown by the sample emails described above, the headers provide information including the date, sender, recipients, and subject of the email message. In addition, messaging server 112 determines whether the headers contain any lines indicating that the message has been upstream processed by a messaging server. For purposes of this example, assume that the email has not been upstream processed.

In addition, the messaging server 112 analyzes 612 the body of the email to determine whether it is composite. As with upstream processing, one embodiment identifies 614 composites by searching the body for text patterns like “Re:” and “----Original Message----.” If 614 the email is not composite, an embodiment of the messaging server 112 creates 616 a new message in the message store 116. The messaging server 112 also creates 618 a new submessage of the newly-created message. The messaging server 112 relationally-associates information from the email with the newly-created message and submessage, including the “from,” “to,” and “cc” email addresses and names, the body and subject, and the date sent and received. If the sender and/or recipient names are already in the message store 116, the messaging server 112 associates the name entries with the new message and submessage. Otherwise, an embodiment of the messaging server 112 creates new user entries in the message store 116.

The messaging server 112 flags 620 the newly-created submessage as “original,” meaning that this submessage is not the result of a reply or forward. In addition, the messaging server 112 computes 620 a hash of the message body and relationally-links this hash to the submessage. Additionally, the messaging server 112 extracts 622 any attachments to the email. These attachments are stored in the message store 116 and linked to the submessage.

If 614 the email is composite, the messaging server 112 separates 624 the individual submessages contained within it. The messaging server 112 identifies 626 the current submessage. If the email follows standard conventions, the first submessage within it is the current message. The messaging server 112 stores 628 the current submessage in the message store, flags it as “original,” and computes the message body hash in the same manner as the submessage of a non-composite email.

For the history submessages in the email message, the messaging server 112 attempts to resolve 628 each submessage by finding the original version of it stored in the message store 116. In one embodiment, the messaging server 112 resolves a submessage by computing a hash of the message body, and then determining whether the message store 116 contains an original submessage having the same hash. If a matching hash is found, the submessage in the composite message is considered another version of the original submessage in the store 116 having the matching hash, and the messaging server 112 creates relational links to indicate this relationship, e.g., the messaging server links the current submessage of the received message to the message in the message store of which the matching submessage is a part. If the messaging server 112 does not find a submessage with a matching hash, it creates a new original version of the submessage in the message store 116. This resolution process is performed for each non-original submessage in the composite email. In addition, the messaging server 112 processes any attachments in the same manner as the submessages.

For example, when processing a composite email, the messaging server 112 might discover that only the current submessage is new, and that the other submessages have already been encountered and corresponding relational submessages are stored in the message store 116. Accordingly, the messaging server 112 creates a submessage in the message store 116 for only the current submessage, and it creates relational links to show that the newly-created submessage is a part of a set of submessages associated with an existing message.

The resolution process 628 can be performed by the messaging server 112 in an offline manner. For example, in one embodiment the messaging server 112 creates a new original submessage for each submessage it encounters in a composite email. Later, the messaging server 112 scans the message store 116 and attempts to resolve the submessages, build the relational message and submessage links that correspond to the submessages, and remove duplicate message components.

In some embodiments, the messaging server 112 may encounter different versions of the same submessage. For example, an end-user might modify a submessage by interspersing comments within it. In one embodiment, the messaging server 112 stores each version of the submessage in the message store 116. The versions are relationally-linked, allowing a client application displaying the message to show each version.

In one embodiment, the messaging server 112 updates 630 the audit data in the message store 116 upon processing the email. For example, the audit data can be updated to indicate that a particular end-user sent a message, received a message, and/or performed another action in the messaging system.

Those of skill in the art will recognize that downstream processing is easier if the message being processed was encoded using upstream processing. Such messages contain explicit identifiers that ease the process of linking the non-relational message components to corresponding relational components in the message store 116. As such, it is not necessary to search for submessages, compute hashes of submessage bodies, or perform other steps that may be required with non-encoded messages. In one embodiment, if a messaging server 112 that receives a message that was upstream processed by another messaging server, the receiving messaging server 112 contacts the other messaging server in order to validate and/or receive the original versions of the message components.

In sum, the messaging server 112 allows emails and other non-relational messages exchanged by the messaging system to be represented in a relational manner. This representation allows relational searches to be executed on the messages, thereby making it possible to perform sophisticated analyses of the messages. In addition, the messaging server 112 eases the process of migrating from a legacy non-relational messaging system to a fully relational messaging system.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

We claim:

1. A computerized messaging server in an electronic messaging system, comprising:
a message store module adapted to store using a relational structure components of messages exchanged in the electronic messaging system; and
a structuring module adapted to receive a non-relational message exchanged using the messaging system, to create a relational counterpart of the non-relational message, and to store the relational counterpart in the message store module.

2. The messaging server of claim 1, wherein the structuring module comprises:
a downstream processing module adapted to analyze the non-relational message to produce a set of message components, to examine the message store module to identify any relationships between the message components of the non-relational message and the message components stored in the message store module, and to create new relational data in the message store module to reflect the identified relationships.

3. The messaging server of claim 2, wherein the message store module is further adapted to store a hash value identifying a message component and wherein the downstream processing module is further adapted to generate a hash value from a message component of the non-relational message and determine whether the hash value from the non-relational component matches the hash value identifying the message component in the message store.

4. The messaging server of claim 1, wherein the structuring module comprises:
an upstream processing module adapted to tag the non-relational message with information including unique identifiers for message components within the non-relational message.

5. The messaging server of claim 4, wherein the non-relational message is in one of a plurality of formats and wherein the upstream processing module is further adapted to identify the format of the non-relational message and insert tags specific to the format.

6. The messaging server of claim 1, further comprising:
a searching module adapted to enable relational searches on the components of messages stored in the message store module.

7. A computer program product having a computer-readable medium having computer program instructions recorded thereon for processing messages exchanged using an electronic messaging system, comprising:
a message store module adapted to store using a relational structure components of messages exchanged in the electronic messaging system; and
a structuring module adapted to create a relational counterpart of the non-relational message exchanged using the messaging system, and to store the relational counterpart in the message store module.

8. The computer program product of claim 7, wherein the structuring module comprises:
a downstream processing module adapted to analyze the non-relational, message to produce a set of message components, to examine the message store module to identify any relationships between the message components of the non-relational message and the message components stored in the message store module, and to create new relational data in the message store module to reflect the identified relationships.

9. The computer program product of claim 8, wherein the message store module is further adapted to store a hash value identifying a message component and wherein the downstream processing module is further adapted to generate a hash value from a message component of the non-relational message and determine whether the hash value from the non-relational component matches the hash value identifying the message component in the message store.

10. The computer program product of claim 7, wherein the structuring module comprises:
an upstream processing module adapted to tag the non-relational message with information including unique identifiers for message components within the non-relational message.

11. The computer program product of claim 10, wherein the non-relational message is in one of a plurality of formats and wherein the upstream processing module is further adapted to identify the format of the non-relational message and insert tags specific to the format.

12. The computer program product of claim 7, further comprising:
a searching module adapted to enable relational searches on the components of messages stored in the message store module.

13. A computer-implemented method of processing messages exchanged using an electronic messaging system, comprising:
providing a data store for storing, using a relational structure, components of messages exchanged in the electronic messaging system;
creating a relational counterpart of a non-relational message exchanged using the messaging system; and
storing the relational counterpart in the message store module.

14. The method of claim 13, further comprising:
analyzing the non-relational message to produce a set of message components;
examining the message store module to identify any relationships between the message components of the non-relational message and the message components stored in the message store module; and
creating new relational data in the message store module to reflect the identified relationships.

15. The method of claim 14, wherein the data store stores a hash value identifying a message component and further comprising:
generating a hash value from a message component of the non-relational message; and
determining whether the hash value from the non-relational component matches the hash value identifying the message component in the data store.

16. The method of claim 13, further comprising:
tagging the non-relational message with information including unique identifiers for message components within the non-relational message.

17. The method of claim 16, wherein the non-relational message is in one of a plurality of formats and further comprising:
identifying the format of the non-relational message and inserting tags specific to the format.

18. The method of claim 13, further comprising:
executing a relational search on the components of messages stored in the data store.
